(19) United States
(12) Patent Application Publication
(10) Pub. No.: US 2026/0359076 A1
(43) Pub. Date: Nov. 12, 2026

(54) AI-Based Adaptive User Interface

(71) Applicant: Zscaler, Inc., San Jose, CA (US)

(72) Inventor: Ayesha Mahmood, Cupertino, CA (US)

(73) Assignee: Zscaler, Inc., San Jose, CA (US)

(21) Appl. No.: 19/201,354

(22) Filed: May 7, 2025

(51) Int. Cl. G06F 9/451; G06F 3/0484; G06Q 10/0631; G06Q 10/0633

(52) U.S. Cl. CPC G06F 9/451; G06F 3/0484; G06Q 10/063114; G06Q 10/0633

(57) ABSTRACT

Systems and methods for personalizing a User Interface (UI) are provided. A method, according to one implementation, includes a step of gathering job-related information associated with a user, the job-related information including at least an occupational role of the user. The method further includes a step of collecting user-driven information associated with the user, the user-driven information including at least historical user interactions. Also, the method includes a step of customizing an adaptive User Interface (UI) for the user based on the job-related information and user-driven information using an Artificial Intelligent/Machine Learning (AI/ML) model.

### TECHNICAL FIELD

The present disclosure generally relates to networking systems and methods. More particularly, the present disclosure relates to customizing a User Interface (UI) for an individual based on role-related information and user-driven information, such as by implementing Artificial Intelligence/Machine Learning (AI/ML) techniques.

### BACKGROUND

In the field of general-purpose computing systems, the ubiquitous User Interface (UI) is the point of interaction between a human user and a digital device, computer, application, or processing system. The UI encompasses the visual elements, controls, and workflows that allow users to input data, receive feedback, and command functionality from the system. The UI acts as a bridge, translating user actions (e.g., clicks, touches, voice commands, etc.) into machine-readable instructions and rendering system responses in a way that is understandable and accessible to humans. A graphical user interface (GUI), for example, is a specific type of UI that relies on visual components (e.g., windows, icons, buttons, menus, dashboards, etc.) to facilitate interaction. GUIs are designed to be intuitive and visually organized, often incorporating layouts, color schemes, typography, and interactive elements to enhance usability and reduce cognitive load. In more complex systems—such as industrial controls, business analytics tools, or automotive systems—the UI may be referred to as a Human-Machine Interface (HMI) or dashboard, emphasizing real-time data display, control inputs, and system monitoring. Effective UI design is essential to ensure efficiency, reduce errors, and improve the overall user experience.

### BRIEF SUMMARY

The present disclosure is directed to systems and methods for personalizing User Interfaces (UIs) for specific individuals. According to one implementation, a method may include a first step of gathering job-related information associated with a user, wherein the job-related information may include at least an occupational role of the user. Also, the method may include a second step of collecting user-driven information associated with the user, wherein the user-driven information may include at least historical user interactions. Finally, the method includes a step of customizing an adaptive UI for the user based on the job-related information and user-driven information using an AI/ML model.

According to some embodiments, the job-related information may further include an organizational team of which the user is a member. Also, the user-driven information may further include personal selections, preferences, and settings. The method may further include a step of customizing the adaptive UI using a Model-View-Presenter (MVP) or Model-View-Controller (MVC) architecture. Another step may include creating personalized automated workflows for the user based on identified repetitive tasks and work patterns. The method may also include a step of personalizing graphic features and widgets of a homepage of the adaptive UI based on user selections, preferences, and settings.

In some embodiments, another step may include personalizing a dynamic navigation section and menu options of the adaptive UI based on navigational history and patterns. Yet another step may include adding contextual assistance information to the adaptive UI based on one or more of a) an observation or anticipation of what the user is attempting to accomplish, b) a large amount of data obtained from multiple global users having the same occupational role, and c) behaviors of team members in a network domain associated with the user.

In addition, the method may further include a step of adding intelligent discovery opportunities to the adaptive UI, wherein the intelligent discovery opportunities may include suggestions or recommendations for enabling the user to a) learn additional skills, b) gain greater expertise within the occupational role, and/or c) incorporate best practices into a workflow. Another step may include adding the intelligent discovery opportunities based on an analysis of a) current events within a field of the occupational role, b) issues detected in a network domain associated with the user, c) possible workflow improvements, d) a potential lack of experience or expertise of the user, e) perceived gaps in knowledge, and/or f) underutilized software tools and features for better performing tasks within a realm of the occupational role.

The AI/ML model for performing these steps may further be configured to use a continuous learning process that includes 1) analyzing new data obtained from a) the user, b) a team associated with the user, and c) global trends, and 2) reconfiguring the adaptive UI based on the new data. Additional steps of the method may also include a) providing a library of modular UI components from which the user can choose, where the library may include suggestions commonly associated with the occupational role, allowing the user to select one or more of the modular UI components, and b) arranging and/or rearranging the one or more modular UI components selected by the user according to additional user input. The methods may be configured to format the adaptive UI for presentation on a desktop computer, laptop computer, a smart phone, and/or a mobile device.

The occupational role, for example, may include a) a cybersecurity analyst, b) a Security Operations Center (SOC) analyst, c) an IT administrator, d) an IT project manager, e) an admin, f) a network operator, g) a hardware technician, h) a software developer, i) a network analyst, j) a database management admin, k) a data scientist, l) a systems admin, m) an information security expert, and/or n) a help desk assistant. The adaptive UI may be configured to display security metrics and security alerts related to this occupational role. In some respects, the adaptive UI may be integrated within a consolidated platform of zero-trust cybersecurity apps, cloud-based apps, and Software as a Service (SaaS) apps.

The methods may also be configured to create a cohesive platform for the user based on a suite of software products available to the user, the cohesive platform thereby offering consistency and efficiency. Another step may include constructing guardrails to a) protect privacy and Personal Identifiable Information (PII) of the user, b) provide restrictions on what the user can be shown based on organizational policies, and c) prevent the display of content considered to be Not Safe (or Suitable) For Work (NSFW). The adaptive UI may include a dynamic layout with customized dashboards for the user based on the occupational role, historical interactions, real-time conditions, current needs and requirements of a network domain associated with the user, current trends, user behaviors, and automated workflow patterns.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a network diagram illustrating a User Interface (UI) customization system, according to various embodiments.

FIG. 2 is a block diagram illustrating a computer device of the UI tailoring server shown in FIG. 1, according to various embodiments.

FIGS. 3A and 3B are diagrams of a Model-View-Controller (MVC) architecture and Model-View-Presenter (MVP) architecture, respectively, according to various embodiments.

FIG. 4 is a diagram illustrating a portal that enables a user to set up a personalized UI, according to various embodiments.

FIGS. 5 and 6 illustrate screenshots of set-up screens for an example with respect to an occupational role related to network security, where FIG. 5 is a screen for determining user interests with respect to the occupational role, and where FIG. 6 is a home page set-up screen, according to various embodiments.

FIG. 7 is a diagram illustrating an example of an adaptive UI with areas for alerts, current workflow items, and suggestions, according to various embodiments.

FIG. 8 is a flow diagram illustrating a method for obtaining large amounts of data with respect to an occupational role, according to various embodiments.

FIG. 9 is a flow diagram illustrating a method for customizing an adaptive UI for a user based on different input information, according to various embodiments.

### DETAILED DESCRIPTION

The present disclosure relates to systems and methods for developing various types of User Interfaces (UIs) that are intended to be intuitive and easy to use. In many conventional computing systems, the UI may be a “static” type of tool for human/machine interactions. That is, many menus and options available to a user are predefined and must be learned through experience and practice. However, according to the embodiments of the present disclosure, the present systems and methods are configured to provide a dynamic, adaptive UI that is customized specifically for an individual user, instead of designing a UI having a static format that various users must adapt to.

For example, using Artificial Intelligence (AI) and Machine Learning (ML) techniques, collectively referred to herein as AI/ML models, various types of information can be collected and used to customize a UI for an individual user. For example, the AI/ML models can use information related to the occupational role of the user. In one case in which the user is a cybersecurity analyst, for instance, the UI can be customized based on the specific unique needs and best practices of others sharing the same role as a cybersecurity analyst. Also, based on other types of information, such as the user's historical activities and behaviors, the AI/ML models can customize the adaptive UI to optimize the user's time and energies by providing suggestions, automating workflows, etc. to assist the user with performing his or her role.

Therefore, one of the pressing challenges many organizations face today is the complexity of existing systems. Traditional software applications often have convoluted interfaces that are hard to navigate, leading to frustration and inefficiencies. Furthermore, the migration to modern software solutions can be daunting, requiring significant time and resources while often encountering resistance from users accustomed to legacy systems. Thus, the systems and methods of the present disclosure are configured to overcome the conventional shortcomings by adapting UIs to a user's needs as opposed to forcing users to adapt to the preconceived static format of complex UI layout.

In some cases, the UIs described in the present may be directed to users having certain roles within a network domain, such as those involving some type of network maintenance and/or cybersecurity. For example, some roles particularly addressed herein, which are not to be limiting in any respect, may include a) a cybersecurity analyst, b) a Security Operations Center (SOC) analyst, c) an IT administrator, d) an IT project manager, e) an admin, f) a network operator, g) a hardware technician, h) a software developer, i) a network analyst, j) a database management admin, k) a data scientist, l) a systems admin, m) an information security expert, n) a help desk assistant, and/or any other occupational role. In some embodiments, for example, a software tool such as Experience Center offered by Zscaler may be customized for users to perform various network security tasks. Again, it should be noted that the systems and methods of the present disclosure may also be configured to customize UIs for users having other roles, jobs, tasks, etc., including teachers, students, executives, gamers, etc.

Also, the UIs described herein may be configured as personalized homepages that users may open when first turning on their computers, when they first log into a domain system, upon boot-up, or other similar initial situations. In some examples, the UIs may also be associated with navigation systems or navigation pages that may be used to assist the users with finding information and accessing various resources. Furthermore, the homepage, navigation page, and/or other UI pages for each user not only might be customized for the user, but also they can be integrated into a suite of related software applications allowing a user to access various functions or applications. As such, this customization provides a familiar personalized view for a user based on their specific needs, frequently utilized tools, workflow patterns, etc. Also, the customization strategies may be related to a) user behavior, b) user-driven interests, preferences, and selections, etc. to create highly customizable dynamic layouts or adaptive UIs based on AI/ML processing. This approach to using AI with contextual understanding of what the user is trying to accomplish can significantly reduce the time-to-value for administrators trying to secure their enterprise network.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

### User Interface (UI) Customization System

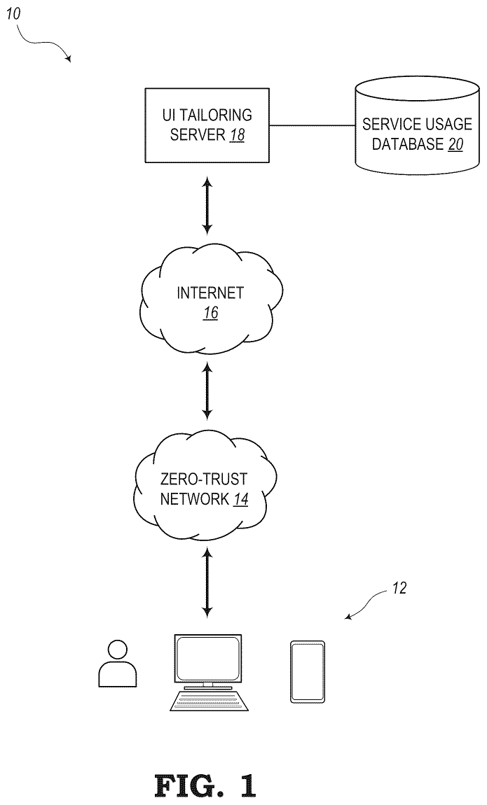

FIG. 1 is a network diagram illustrating an embodiment of a User Interface (UI) customization system 10 of a communications network. In particular, the UI customization system 10 is configured to create a customized UI for one or more users based on specific data associated with each user. For instance, an adaptive UI may be generated using AI/ML models using historical user interactions, an occupational role of the user, user behavior and activities, actions taken by other members of teams of which the user participates, best practices based on regional, state-wide, nation-wide, and/or global analysis of other users having similar roles, etc.

As shown in FIG. 1, the UI customization system 10 includes one or more user devices 12 associated with a user for which a customized UI is to be developed. In some embodiments, the UI customization system 10 may further include a zero-trust network 14, which is configured for the purpose of network security when the user devices 12 access the Internet 16. Additionally, the UI customization system 10 includes a UI tailoring server 18 configured to provide a cloud-based service, Software as a Service (SaaS), or the like, for one or more users for enabling UI customization for each user. The UI tailoring server 18 may be associated with a service usage database 20 (e.g., Large Language Model (LLM) or the like), which may be configured to store and process information regarding roles, service usage, best practices, trends, available software and functionality with respect to each role, etc.

### UI Tailoring Server

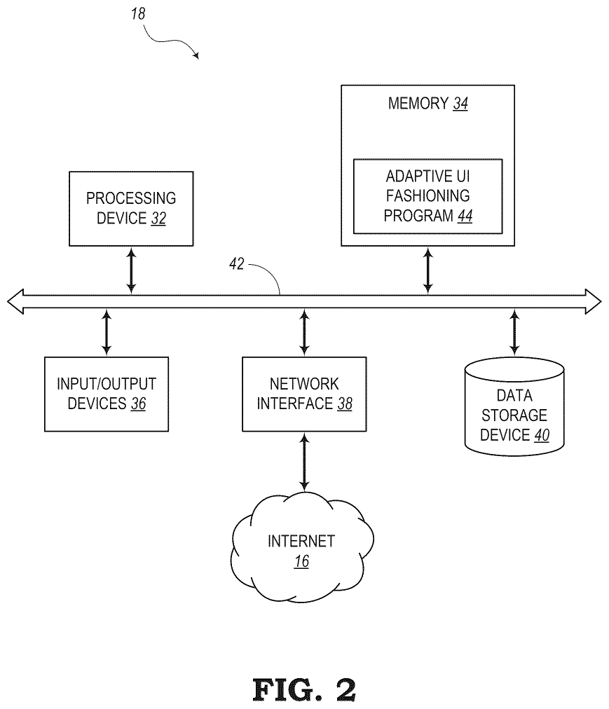

FIG. 2 is a block diagram illustrating an embodiment of a computer device associated with the UI tailoring server 18 shown in FIG. 1. In various embodiments, the systems and methods described herein may be implemented using one or more computing systems configured to perform artificial intelligence (AI) operations, including but not limited to training machine learning models, executing inference operations, performing data analysis, or generating output based on learned representations.

The computing system of the UI tailoring server 18 may be suitable for implementing aspects of the present disclosure. As such, the computing system may include a general-purpose computer, a specialized computing device, or a distributed network of such devices. The computing system may include one or more processing devices, such as a central processing unit (CPU), graphics processing unit (GPU), tensor processing unit (TPU), digital signal processor (DSP), application-specific integrated circuit (ASIC), field-programmable gate array (FPGA), or other specialized or general-purpose hardware capable of executing software instructions, referred to collectively as a processing device 32.

The processing device 32 may be configured to execute instructions stored on one or more non-transitory computer-readable media, such as a memory 34 or other suitable memory device. The instructions may include machine learning algorithms, deep learning models, natural language processing techniques, neural network training procedures, or other artificial intelligence logic. The instructions, when executed, may enable or cause the processing device 32 to perform the AI-related functions described herein.

The computing system may also include one or more memory components. The memory 34 may include volatile memory (e.g., random-access memory or RAM), non-volatile memory (e.g., read-only memory or flash memory), or other types of memory suitable for storing computer-executable instructions, model parameters, training data, inference data, feature vectors, or any other data associated with the AI processes described herein. In some embodiments, the memory 34 may include an adaptive UI fashioning program 44 configured to fashion a customized UI for an individual user.

The computing system may further include one or more input/output (I/O) devices 36 or interfaces that permit user interaction, data ingestion, or control of the system. I/O interfaces may be used to receive raw data, user commands, sensor inputs, or real-time streaming inputs (e.g., audio, image, or video), and to present outputs such as classification results, predictions, recommendations, or generated content.

The computing system may also include a network interface 38, which may also be included to facilitate communication with the Internet 16, the zero-trust network 14, external data sources, cloud-based model repositories, or other computing devices. Such interfaces may include support for standard networking protocols and interfaces (e.g., TCP/IP, HTTP, gRPC, REST APIs) and may enable the system to operate in a distributed or cloud-based computing environment.

In some embodiments, the system may include a data storage device 40, which may be implemented using one or more data storage systems, databases, data stores, etc. The data storage device 40 may be configured to store training datasets, test datasets, model weights, hyperparameters, or other data used in connection with AI operations. In some embodiments, the data storage device 40 may include relational databases, key-value stores, graph databases, or distributed file systems.

Also, the processing device 32, memory 34, I/O devices 36, network interface 38, and data storage device 40 may be interconnected via a local interface 42, which may include one or more communication buses or interconnects. The local interface 42 may include PCIe, NVLink, system-on-chip (SoC) interconnects, or other high-throughput communication channels suitable for data-intensive AI workloads.

In some embodiments, the computing system may be implemented using a cloud computing environment or a containerized architecture, enabling scalability, deployment of microservices, and distributed training or inference. Virtual machines, containers (e.g., Docker), or orchestration frameworks (e.g., Kubernetes) may be used to manage AI service deployment.

Unless specifically stated otherwise, the term “computer-readable medium” as used herein refers to one or more physical storage media that store computer-executable instructions. The term excludes transitory media such as signals or carrier waves. For example, the adaptive UI fashioning program 44 may be stored in a non-transitory computer-readable medium and may be configured to enable the automated customization of a UI for a user based on specific job-related information and user-driven information.

The adaptive UI fashioning program 44 may be configured to offer users a personalized experience to thereby improve User Experience (UX) metrics. It can ensure that the UI is adapted specifically to an individual user based on behavior and contextual understanding of the user's common workflows. In addition, the adaptive UI fashioning program 44 is configured to provide UIs that also have the ability to make suggestions based on the best practices and user activity data, which can thereby lead to continued learning by the user, greater skills and expertise, getting up to speed on certain topics and new trends, etc. The UIs may be generated to offer accessibility and usability by personalizing a design that can be inclusive and user-friendly and can accommodate users with varying levels of technical expertise.

Thus, the UI fashioning program 44 is configured to further efforts with respect to platforming multiple software tools and can build a cohesive UI across numerous and diverse products to drive consistency and efficiency. It is believed that in the age of AI, the customization of UIs can be significant advantage for allowing any user at any skill level to be driven to greater understanding and skill, while also providing a familiar platform that can automate repetitive tasks to allow the user to perform higher level tasks. It is also believed that in this new technological era, the significance of meshing UI and UX designs is becoming increasingly pronounced. The embodiments of the present disclosure are configured to evolve UI/UX frameworks beyond mere visual appeal. The benefits of the present systems and methods are configured to emerge as a crucial differentiating factor in a landscape increasingly influenced by AI. It is believed that organizations that grasp and harness this shift will distinguish themselves in a crowded market.

### MVP and MVC Architectures

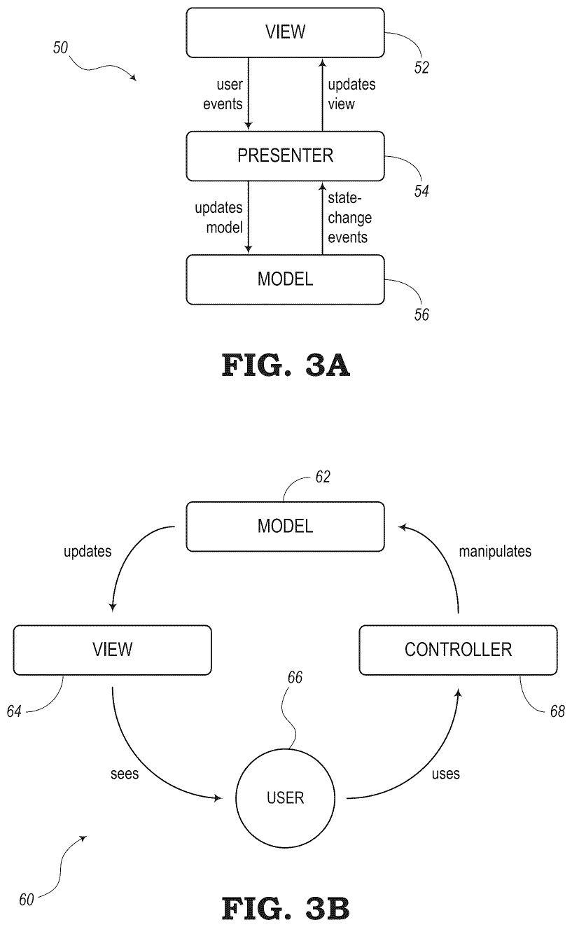

FIGS. 3A and 3B are diagrams showing embodiments of a Model-View-Presenter (MVP) architecture 50 and a Model-View-Controller (MVC) architecture 60, respectively. It some respects, the MVP architecture 50 may be considered as a subset of the MVC architecture 60. These and other templates may be utilized by AI/ML models for assisting with the creation of user-customized UIs as described in the present disclosure.

As shown in FIG. 3A, the MVP architecture 50 includes a view unit 52, a presenter unit 54, and a model unit 56. User events may be communicated from the view unit 52 to the presenter unit 54. The presenter unit 54 may be configured to update the model unit 56. The model unit 56 may be configured to provide state change events to the presenter unit 54. The presenter unit 54 may be configured to update the view in the view unit 52.

The MVP pattern of the MVP architecture 50 may be used primarily for building UIs. The presenter unit 54 may assume the functionality of a “middleman,” whereby presentation logic may be pushed to the presenter unit 54. The MVP model may be utilized to facilitate an automated unit testing to improve the separation of concerns in presentation logic. That is, the model unit 56 may be an interface defining the data to be displayed or otherwise acted upon in the user interface. The view unit 52 may be a passive interface that displays data (the model) and routes user commands (events) to the presenter unit 54 to act upon that data. The presenter unit 54 may act upon the model and the view and can retrieve data from repositories (the model) and format it for display in the view. The view unit 52 may be configured to instantiate the concrete presenter object, providing a reference to itself.

The degree of logic permitted in the view varies among different implementations. At one extreme, the view may be entirely passive, forwarding all interaction operations to the presenter. In this formulation, when a user triggers an event method of the view, it does nothing but invoke a method of the presenter that has no parameters and no return value. The presenter may then retrieve data from the view through methods defined by the view interface. Finally, the presenter operates on the model and updates the view with the results of the operation. Other versions of MVP may allow some latitude with respect to which class handles a particular interaction, event, or command. This is often more suitable for web-based architectures, where the view, which executes on a client's browser, may be the best place to handle a particular interaction or command. From a layering point of view, the presenter class might be considered as belonging to the application layer in a multilayered architecture system, but it can also be seen as a presenter layer of its own between the application layer and the user interface layer.

As shown in FIG. 3B, the MVC architecture 60 includes a model unit 62, a view unit 64, a user 66, and a controller unit 68. The model unit 62 provides updates to the view unit 64, allowing the user 66 to see the outputs. The user 66 uses the controller unit 68 to manipulate the model unit 62.

In the MVC format, the MVC may be a software architectural pattern commonly used for developing user interfaces that divide related program logic into three interconnected elements. These elements may include a) the model unit 62, which includes an internal representations of information, b) the view unit 64, which may include the interface that presents information to and accepts it from the user, and c) the controller unit 68, which may include the software linking the two.

The model unit 62 of the MVC architecture 60 may be the central component of the pattern. It can be the application's dynamic data structure, independent of the user interface. It can directly manage the data, logic, and rules of the application. The model unit 62 can keep the data organized and consistent. Also, it can ensure that the application's data behaves according to the defined rules and logic.

The view unit 64 may include any suitable representation of information, such as a chart, diagram, or table. Multiple views of the same information may be possible, such as a bar chart for management and a tabular view for accountants. The view may represent a complete user interface element (e.g., menu, button, etc.) and receives input from the user. In some cases, the views may be meant to be general-purpose and composable.

In some embodiments, the controller unit 68 may be configured to accept input and convert it to commands for the model or view. The controller can handle user input events, such as button presses, mouse movements, etc. At any given time, each controller may have one associated view and model, although one model object may hear from many different controllers. Only one controller, the “active” controller, may be configured to receive user input at any given time. If, for example, a user input prompts a change in a model, the controller may be configured to signal the model to change, such that the model may then be responsible for telling its views to update.

According to some embodiments of the MVP and MVC models, the design architecture may be configured to focus on data collection. Generic data models may drive reusable components to enable various user cases for generating an adaptive UI for various users. One goal may include generating these customized UIs to increase active users and usage frequency of key features. According to surveys of experimental use, the customized UIs, generated according to the embodiments of the present disclosure, have received positive feedback regarding their usability and personalization, particularly in the context of network security roles.

### Personalized Homepage Portal

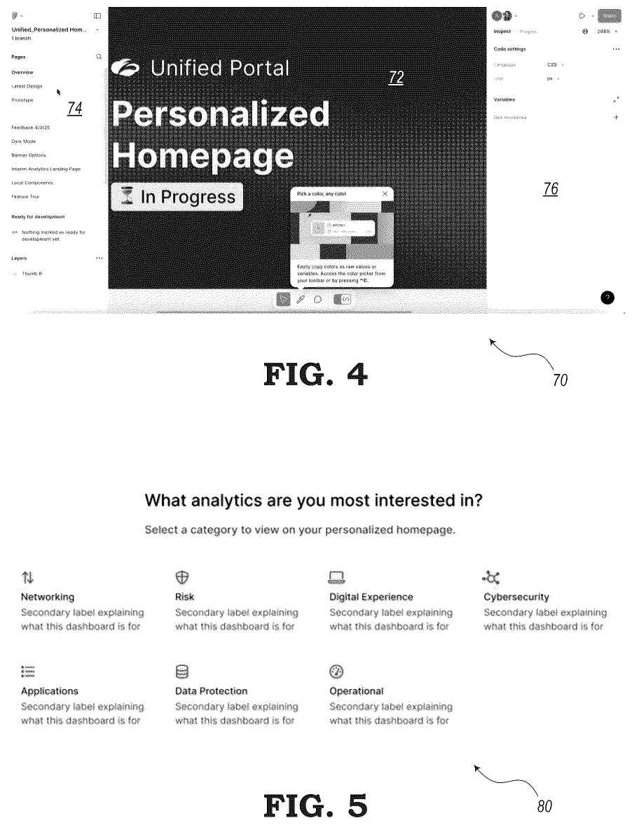

FIG. 4 is a diagram illustrating an embodiment of a portal 70 that enables a user to set up a personalized UI. The portal 70 may be configured to provide a sample of the user selections and preferences and enable personalization and customization as desired. The portal 70 includes a central display area 72, which may be configured as a main window in which user interactions may occur and may represent the present status of user selections. Also, the portal 70 includes a left-hand section 74, which may include various menu options, drop down selections, etc. The portal 70 further includes a right-hand section 76, which includes additional selection options for customizing the UI.

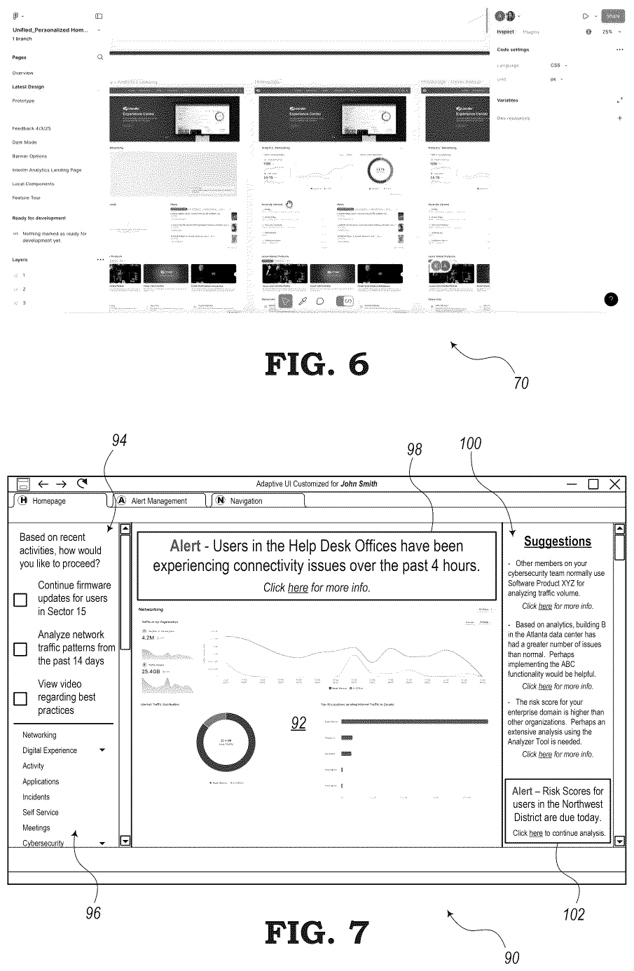

FIGS. 5 and 6 illustrate examples of screenshots associated with the set-up described with respect to FIG. 4 in which a user performs certain personalization actions to customize the UI for himself or herself. FIG. 5 shows a set-up screen 80 with respect to an occupational role related to network security. In particular, the set-up screen 80 allows the user to personalize how various cybersecurity categories can be presented, based on what analytics the user may be interested in. For example, the user can select and customize a) a networking dashboard or widget, b) a risk dashboard or widget, c) a digital experience dashboard or widget, d) a cybersecurity dashboard or widget, e) an applications dashboard or widget, f) a data protection dashboard or widget, and/or g) an operational dashboard or widget. Also, FIG. 6 shows a set-up screen 70 within a central section that provides various UI layouts that the user may select. Again, the examples shown may be directed to roles that are associated with network security, while other roles can be represented in other ways depending on the various details of these roles.

### Example of an Adaptive UI

FIG. 7 is a diagram illustrating an example of an adaptive UI 90 with areas for alerts, current workflow items, and suggestions. For example, the adaptive UI 90 may be a finalized UI presentation resulting from the previous set-up processes described with respect to the embodiments of FIGS. 3-6 . The adaptive UI 90 is shown during use, having been customized according to the user's role, team-wide knowledge, global trends, current events, historical user behavior, network status, etc.

The adaptive UI 90 of FIG. 7 is shown during operation (e.g., an ordinary day in the life of a network security specialist, or the like). In this embodiment, the adaptive UI 90 includes a central section 92, which may be configured to show networking conditions. In this example, the organizational traffic is displayed in graphical form over the past 14 days and is shown to include 4.2 million transactions. Also, the traffic volume is shown in graphical form over the same time period and includes 25.4 GB of traffic. Also, the central section 92, in this example, includes Internet traffic distribution of the 25.4 GB, where a large percentage is devoted to “road warriors” (e.g., remote workers) and the rest is devoted to offices in different cities.

Furthermore, the adaptive UI 90 includes a section 94 related to historical user behaviors. For example, based on an analysis of the user's activities, the adaptive UI 90 can provide a list of the same or similar activities that the user may wish to continue or may be required to perform based on deadlines, typical scheduled workloads, regular workflow activities, etc. In this example, the user may be prompted if he or she might wish to proceed with a number of check-list items, such as “continue firmware updates for users in sector 15,” “analyze network traffic patterns form the past 14 days,” “view video regarding best practices,” etc. Also, the left side of the adaptive UI 90 may also include a window 96 that include regular menu items, which may be typical for many UIs that do not also include the customization features described herein. Thus, the user still has access to these common tabs, selections, drop-downs, etc. for performing certain tasks.

In addition, the adaptive UI 90 includes an alert window 98, which may be presented on top of or overlaying the central section 92 (e.g., at the top of the central section 92) or place in another prominent location to draw the user's attention to an important message. According to some embodiments, if no urgent messages need to be conveyed to the user, the alert window 98 may be omitted or minimized. In the example shown in FIG. 7, the message includes in the alert window 98 is created to communicated to the network security analyst that “Users in the Help Desk Offices have been experiencing connectivity issues over the past four hours.” The alert window 98 may also include a suitable link or the like, such as a message saying, “Click here form more info,” whereby clicking on the hyperlink can be configured to navigate the user to an additional page or cause a window to pop up, giving the user more information (e.g., data, graphs, tables, etc.) about the situation.

Additionally, the adaptive UI 90 may further include a suggestion section 100, which may be configured to display a list of suggestions that can help the user to perfect his or her craft, increase their expertise, coordinate with colleagues, perform scheduled tasks, address certain issues, etc. Of course, in the case where the user has a different role other than a network security expert, other types of suggestions can be provided based on role, user activities, field of expertise, perceived opportunities for improvement, etc. In some embodiments, one or more additional alert windows 102 may be positioned in the adaptive UI 90 for communication various messages to the user.

It may be noted that a goal of the adaptive UI 90 in an AI-enhanced context may include designing an interaction medium that can be built for multiple uses and multiple apps and software tools. Instead of branching out into unfamiliar website formats, the user can view various sites and utilize multiple apps through one unified interface. It can be customized and edited as the user desires to provide a simple environment that is comfortable for the user and can meet his or her needs. Thus, the adaptive UI 90 can be designed by the user yet enhanced with AI/ML technology to increase expertise, keep the user up to date on the latest developments in a particular field, gently push the user to try different functionality within available software resources that may boost the user's performance and effectiveness. The adaptive UI 90 can be intuitive, responsive, and adaptive and may be configured to evolve based on current user interactions and preferences, new user inputs, new presentations and meetings regarding topics related to the user's role, etc., thereby creating a cohesive experience that is tailored to each individual.

UI/UX design and engineering may be configured to advance, according to the embodiments described herein, such that this movement toward personalized engagement may become prevalent, whether it is embedded in a desktop computer, laptop computer, tablet, smart phone, cell phone, mobile device, vehicle, IoT devices, industrial equipment, SaaS applications, etc. As AI technologies advance, they can analyze user behavior through usage telemetry, which can be an essential tool that provides insights into daily interactions. By comprehending how users engage with their devices, software companies can make strategic adjustments to the interface. For example, the adaptive UI 90 might emphasize commonly used features, recommend shortcuts, or even automate specific tasks, thereby improving efficiency and user contentment.

The adaptive UI 90 can be based on AI and workflow experiences. One of the pressing challenges many organizations face today is the complexity of existing systems. For instance, traditional software applications often have convoluted interfaces that can be difficult to navigate, not geared to the user's tastes, time-consuming to understand, etc., which can thereby lead the user to frustration and inefficiencies, especially as an employee is expected, upon being hired, to produce positive results right away without sufficient orientation time. Furthermore, the migration to modern software solutions can be daunting, requiring significant time and resources while often encountering resistance from certain users who may be accustomed to legacy systems. Thus, AI has the potential to transform workflow-based experiences by simplifying interactions and streamlining processes.

In some embodiments, the adaptive UI 90 may, again, be configured to produce role-based dashboards. The AI/ML models and set-up processes can be configured to create customizable dashboards that are dynamic in nature and display relevant role-specific metrics and alerts based on user roles (e.g., security metrics and alerts for network security personnel). Also, the AI/ML models can monitor and analyze user activities for determining ways to improve efficiency, which may include automating certain repetitive tasks that do not necessarily need human involvement. Also, the adaptive UI 90 can be configured to provide dynamic insights related to the user's role (e.g., threat insights for a network security analyst). The adaptive UI 90 can adaptively present threat intelligence and risk assessments tailored to the user's operational context and recent activities.

### UI Customization Methods

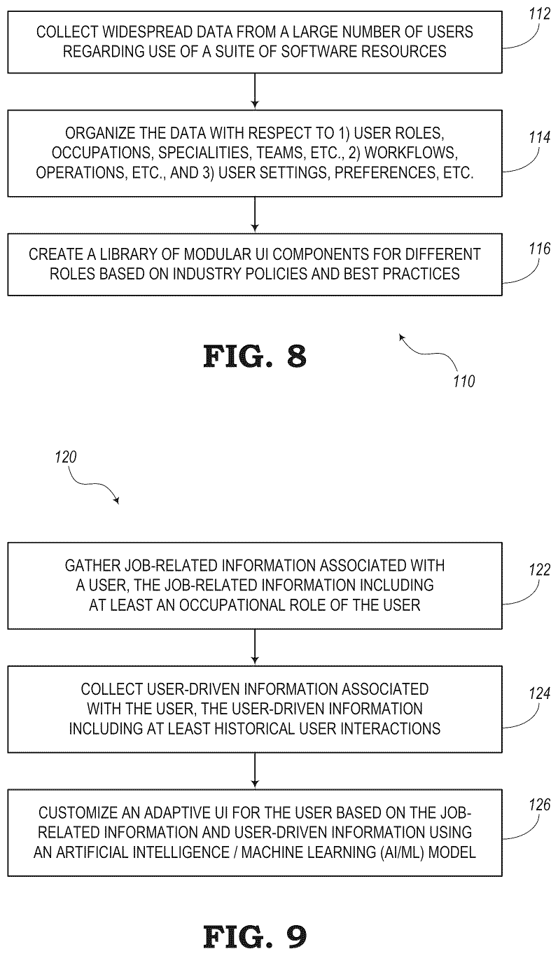

FIG. 8 is a flow diagram illustrating an embodiment of a method 110 for obtaining large amounts of data with respect to an occupational role. As shown in FIG. 8, the method 110 includes a step of collecting widespread data from a large number of users regarding use of a suite of software resources, as indicated in block 112. The data may be collected over multiple tenants using the software suite, where the identity of the users can be kept confidential. The collection may include the use of LLMs and large scale databases. The method 110 further includes a step of organizing the data with respect to a) user roles, occupations, specialties, teams, etc., 2) workflows, operations, etc., and 3) user settings, preferences, etc., as indicated in block 114. Next, the method 110 includes a step of creating a library of modular UI components (e.g., widgets, windows, graphs, etc.) for different roles based on industry policies and best practices, as indicated in block 116.

FIG. 9 is a flow diagram illustrating an embodiment of a method 120 for customizing an adaptive UI for a user based on different input information. As shown, the method 120 includes a step of gathering job-related information associated with a user, as indicated in block 122, wherein the job-related information includes at least an occupational role of the user. In addition, the method 120 includes a step of collecting user-driven information associated with the user, as indicated in block 124, wherein the user-driven information includes at least historical user interactions. Furthermore, the method 120 includes a step of customizing an adaptive UI for the user based on the job-related information and user-driven information using an AI/ML model, as indicated in block 126.

The following description includes a number of functions that may be incorporated into the adaptive UI 90 according to various implementations:
1) Intelligent Automation—The adaptive UI 90 can implement AI capabilities to identify and automate repetitive tasks (e.g., filtering on certain fields, config and admin updates) to allow the user to focus on operations that may need human decision-making. The AI/ML models may identify and automate repetitive tasks, reducing the time users spend on mundane activities. For example, processes like data entry, scheduling, and reporting can be managed by AI systems, allowing users to focus on higher-value tasks that require human judgment and creativity. Intelligent Automation may also include integration with existing tools to automate workflows (e.g., Work From Anywhere (WFA), AI for IT Operations (AIOps), incident alerts, etc.). The adaptive UI 90 can include user-configurable automation settings for personalization.
2) Personalized Workflows—The adaptive UI 90 can be configured to create adaptive workflows based on user behavior analysis. AI-driven analysis of user interactions can be used to tailor the interface, wherein the homepage may be used as the personalized landing experience to show quick suggestions. The adaptive UI 90 can include customizable workflow templates based on user roles and preferences. By analyzing user behavior and preferences, AI can create personalized workflows tailored to individual users or teams. This means that rather than forcing users to adapt to a one-size-fits-all system, the AI can adjust the interface and functionality to align with how different users work, making the overall experience more intuitive.
3) Contextual Assistance—The adaptive UI 90 can also provide real-time contextual help and recommendations. The AI/ML operations can collect metadata needed to understand current user tasks that can be leveraged by AI, ML, Large Language Models (LLMs), Natural Language Processing (NLP), etc. The AI/ML models can suggest relevant resources, shortcuts, or guidance based on user context. AI can provide contextual help and recommendations as users navigate complex software environments. By understanding the user's current task, AI can suggest relevant resources, shortcuts, or even offer real-time guidance, significantly reducing the learning curve associated with new software.
4) Seamless Integration—The adaptive UI 90 can use AI-enabled systems that can integrate seamlessly with existing tools, making it easier for organizations to transition to new software. This integration can help mitigate the challenges of migration by allowing users to gradually adapt to new functionalities without disrupting their established workflows. This integration may focus on accessibility, where design UI modular elements with accessibility in mind can be used for all users, regardless of their capabilities. An inclusive design philosophy can expand market reach and improve the overall user experience.
5) Feedback and Learning Loops—The adaptive UI 90 can include AI that can continuously learn from user interactions, enabling systems to evolve based on real-time feedback. This capability means that as users engage with the software, the AI can identify pain points and make adjustments to improve usability and efficiency over time. This may include continuous feedback. For example, the method 110 of FIG. 8 can include a feedback loop to continuously collect new data over time, re-organize data, and create and modify the modular UI components in an evolving fashion based on changing trends and other factors. Also, the method 120 of FIG. 9 can similarly repeat the steps defined in blocks 122, 124, 126 to continuously gather information and further customize and tweak the adaptive UI based on updated information. The AI can therefore establish systems for continuous user feedback. This will enable teams to refine designs based on real-world usage, ensuring that the UI remains pertinent and effective.
6) Personalization—According to the embodiments described herein, it may be anticipated that, in the near future, UI will become an environment that adjusts dynamically to user requirements. The adaptive UI 90 is configured to enable personalization and customization based on role-related information, historical user interactions, direct user involvement (e.g., selection of modular UI components, entering preferences, etc.). When a user logs into their platform (e.g., cybersecurity analyst logging onto their cybersecurity platform), the adaptive UI 90 is made aware of the user's role (if not already entered). The adaptive UI 90 monitors daily workflows, compares it with teammates and others having a similar role in other domains, and then presents the user with everything they may need to accomplish, while reducing their time-to-value significantly by directly the user in the right direction, providing a comfortable or familiar dashboard layout, etc. As AI progresses, it will enable interactions that feel less transactional, and more conversational. The UI will act as a conduit between users and technology, simplifying complex functionalities. In some respects, the personalization may include a data-informed design, such as by gathering and analyzing user data to understand their preferences and behaviors. This information can guide UI design choices and help create a more intuitive UI that anticipates the needs of the user.
7) Design—The adaptive UI 90 can be developed as a collection of modular UI components driven by generic data models, including data visualization. The AI/ML models can gather user data on interactions and preferences, informing UI design choices and improving usability, avoiding collection of PII, focusing on behavior, and interactions. Also, this may lay the groundwork for future UI. To realize this vision, teams can concentrate on developing a comprehensive library of modular components. These components can be integrated seamlessly with robust data models to allow extensibility and customization. This modular approach enables designers and developers to combine various UI elements, crafting unique experiences tailored to specific user needs. Furthermore, this may include the use of reusable component libraries, by creating a collection of adaptable UI components that can be easily composed to build data model driven personalized layouts. Additionally, dynamic UI rendering layers, data model driven layout, and visualization recommendation systems can greatly help with the personalized user interfaces. The UI design may also include cross-functional collaboration. For example, this may include cultivating a cooperative environment where design, engineering, AI/ML, and data teams work in tandem. This multidisciplinary approach can yield innovative solutions that enhance the user experience.

### Summarization of Embodiments

Therefore, systems and methods of the present disclosure may be configured to perform certain functional actions for customizing an adaptive UI. The embodiments may be performed by systems (e.g., UI tailoring server 18 having the processing device 32 and the memory 34), as shown in FIG. 2. For example, the system may include the adaptive UI fashioning program 44 implemented in a non-transitory computer-readable medium for executing certain UI customization functions. The methods may include the functionality of these physical systems and may correspond to the methods 110 and 120 described with respect to FIGS. 8 and 9. Also, the embodiments may be implemented in a computer program having instructions that, when executed, enable the processing device 32 or a method. The system/method may include a first step of gathering job-related information associated with a user, wherein the job-related information may include at least an occupational role of the user. Also, a second step may include collecting user-driven information associated with the user, wherein the user-driven information may include at least historical user interactions. Finally, the system or method includes a step of customizing an adaptive UI for the user based on the job-related information and user-driven information using an AI/ML model.

According to some embodiments, the job-related information may further include an organizational team of which the user is a member. Also, the user-driven information may further include personal selections, preferences, and settings. The system or method may further include a step of customizing the adaptive UI using a Model-View-Presenter (MVP) or Model-View-Controller (MVC) architecture. Another step may include creating personalized automated workflows for the user based on identified repetitive tasks and work patterns. The system/method may also include a step of personalizing graphic features and widgets of a homepage of the adaptive UI based on user selections, preferences, and settings.

In some embodiments, another step may include personalizing a dynamic navigation section and menu options of the adaptive UI based on navigational history and patterns. Yet another step may include adding contextual assistance information to the adaptive UI based on one or more of a) an observation or anticipation of what the user is attempting to accomplish, b) a large amount of data obtained from multiple global users having the same occupational role, and c) behaviors of team members in a network domain associated with the user.

In addition, the systems and methods of the present disclosure may further include a step of adding intelligent discovery opportunities to the adaptive UI, wherein the intelligent discovery opportunities may include suggestions or recommendations for enabling the user to a) learn additional skills, b) gain greater expertise within the occupational role, and/or c) incorporate best practices into a workflow. Another step may include adding the intelligent discovery opportunities based on an analysis of a) current events within a field of the occupational role, b) issues detected in a network domain associated with the user, c) possible workflow improvements, d) a potential lack of experience or expertise of the user, e) perceived gaps in knowledge, and/or f) underutilized software tools and features for better performing tasks within a realm of the occupational role.

The AI/ML model for performing these steps may further be configured to use a continuous learning process that includes 1) analyzing new data obtained from a) the user, b) a team associated with the user, and c) global trends, and 2) reconfiguring the adaptive UI based on the new data. Another step of these systems and methods may also include a) providing a library of modular UI components from which the user can choose, where the library may include suggestions commonly associated with the occupational role, allowing the user to select one or more of the modular UI components, and b) arranging and/or rearranging the one or more modular UI components selected by the user according to additional user input. The systems and methods may further be configured to format the adaptive UI for presentation on one or more of a desktop computer, laptop computer, a smart phone, and a mobile device.

The occupational role, for example, may include a) a cybersecurity analyst, b) a Security Operations Center (SOC) analyst, c) an IT administrator, d) an IT project manager, e) an admin, f) a network operator, g) a hardware technician, h) a software developer, i) a network analyst, j) a database management admin, k) a data scientist, l) a systems admin, m) an information security expert, and/or n) a help desk assistant. The adaptive UI may be configured to display security metrics and security alerts related to this occupational role. In some respects, the adaptive UI may be integrated within a consolidated platform of zero-trust cybersecurity apps, cloud-based apps, and Software as a Service (SaaS) apps.

The systems and methods may also be configured to create a cohesive platform for the user based on a suite of software products available to the user, the cohesive platform thereby offering consistency and efficiency. Another step may include constructing guardrails to a) protect privacy and Personal Identifiable Information (PII) of the user, b) provide restrictions on what the user can be shown based on organizational policies, and c) prevent the display of content considered to be Not Safe (or Suitable) For Work (NSFW). The adaptive UI may include a dynamic layout with customized dashboards for the user based on the occupational role, historical interactions, real-time conditions, current needs and requirements of a network domain associated with the user, current trends, user behaviors, and automated workflow patterns.

Thus, the dynamic homepage (e.g., the adaptive UI 90 of FIG. 7) may be created to show relevant information based on detected information. The homepage may include customizable widgets that display data based on user activity. It can also include real-time updates to reflect changes in user tasks or priorities. Furthermore, an adaptive navigation page may be incorporated in the homepage or may be standalone page for enabling the user to navigate to relevant resources, tools, and information as needed. The navigation page may be developed as an area within a navigation system that evolves based on user engagement, pushing up the high frequency workflows or suggestions. It may include dynamic menu structures that highlight frequently used features. Also, it may include a responsive design that adjusts to user interactions and preferences.

Regarding various use cases for users having different roles and operations, a first example scenario involves a security analyst. In this example, suppose the security analyst wishes to log into his or her dashboard and see the most critical threats and alerts relevant to his or her role, so they can respond quickly to potential incidents. A second example scenario involves an IT administrator. In this example, suppose the IT administrator wishes to have a part of the navigation system to be changed based on his or her current security task, so that they can efficiently access the necessary tools without confusion. In a third example scenario, suppose a cybersecurity analyst wishes to receive AI-driven recommendations for addressing potential security vulnerabilities. In this case, he or she can take proactive measures to protect the enterprise systems.

### Additional Considerations

The systems and methods are focused on an adaptive and dynamic UI leveraging AI/ML technologies, particularly tailored for cybersecurity applications (e.g., those available through Zscaler). According to current UI limitations, such as static dashboards, there is an inherent complexity requiring domain expertise. Therefore, embodiments of adaptive UIs are proposed herein that dynamically generate personalized content and navigation based on user roles, historical interactions, and real-time requirements.

The embodiments of the present disclosure may include features such as personalized workflows, contextual assistance, intelligent discovery of automated tasks, and adaptive navigation elements. One goal of the present implementations is to streamline user experiences, reduce cognitive load, and accelerate task completion by proactively suggesting actions, configurations, and best practices.

In some embodiments, the systems and methods described in the present disclosure may be incorporated into new or existing software applications or software suites. For example, the functionality for customizing UIs, as described in the present disclosure, may be incorporated in Zscaler's Experience Center application. This would provide one platform—driving towards simplicity, control, and efficiency. As a security platform, the systems and methods described herein can provide a consolidated, intuitive, and outcome—driven user interface. The adaptive UI can be a user-friendly unified console that can enable administrators to deliver comprehensive cyberthreat and data protection outcomes, providing system-wide analytics and GenAI-driven interactive experiences to streamline day-to-day administration.

There may be at least three key benefits of the new embodiments:
1) Radical simplicity for a user to start his or her zero trust journey—Many organizations are embracing zero trust as the best way to improve their security in an increasingly hostile online environment. Others are beginning to see mandates driving adoption of a zero trust framework. The challenge is always the same—getting started. Whatever the spark for security transformation, the Experience Center can provide an intuitive window into the tools that make it a reality.

IT teams can now onboard users, set up traffic forwarding, and configure security policies using an easy point-and-click workflow. The embodiments described herein may include a guided walkthrough that integrates identity, automates distribution of endpoint agents, and configures zero trust security policies, including advanced threat and data protection, following industry best practices. With this, organizations can enable their zero trust journeys without the complexity of juggling multiple tools, configuration techniques, and onboarding processes.
2) Boost user experience and cybersecurity efficiency with advanced management (e.g., unified management of a comprehensive security platform)—An integrated platform is configured to bring together management for Internet and SaaS applications, private applications, digital experience monitoring (DEM), and endpoint agents. The embodiments described herein and/or the Experience Center are configured to leverage a unified identity layer with granular role-based access control (RBAC) for admin users, featuring persona-driven workflows to cater to a wider range of user types and organizations. It provides one place to define comprehensive security policies across endpoints, cloud, locations, and workloads.
1. A common policy framework for access controls, cybersecurity, data protection, and digital experience management
2. Seamless management of cybersecurity policies for internet, SaaS, and private applications

Simplified workflows for IT and security personas—By simplifying workflows around a common policy framework across internet security, SaaS applications, and private applications, the embodiments herein may improve productivity for IT personas as they go about their work and drives real-world outcomes. Anyone from CISOs/CIOs to networking and cybersecurity practitioners can leverage the console to manage their day-to-day operations efficiently.
3) Analytics and AI can drive efficiency in cybersecurity—The adaptive UI 90 is configured to deliver a cohesive and dynamic experience, featuring an intuitive layout that facilitates persona focused analytics views, as well as interactive experiences powered by a generative AI copilot. Unified analytics make it a breeze to navigate across consolidated views, from users to cyber and data protection, ensuring administrators and IT leaders can quickly snapshot events across their organization.

The following are additional benefits:
The AI/ML models can gain deep insights into the performance and health of the zero trust infrastructure. They can analyze traffic pattern trends across users, geographic locations, and application connectors. They can understand sources of traffic origination and optimize zero trust infrastructures with a unified view serving both internet/SaaS and private traffic.
The AI/ML models can stay ahead of cyber threats. They can actively monitor cyber threat trends, including blocked malicious transactions, an organization's ability to handle zero day threats, gaps in encrypted traffic inspection, and blocked exploits.
The AI/ML models can unify silos with digital experience monitoring. They can get a complete view of an organization's overall digital experience from users to applications and networks. They can enhance the user's understanding of end user experiences by examining data from diverse sources such as ISP outages, Wi-Fi hotspots, and latency summaries.

The systems and methods of the present disclosure may be configured as a Generative AI-powered copilot that can reduce the IT burden. The present embodiments can incorporate an AI-driven virtual assistant designed to simplify and enhance IT operations through an advanced conversational interface. By integrating AI into the core of our network and security operations tools, the GenAI or copilot allows users to interact with their systems using natural language. For example, it can be a great benefit for a service desk team to simply be able to ask for the cause of a network slowdown, and get an answer quickly, based on the parsing of multiple data sources (e.g., Wi-Fi, LAN, ISP, cloud).

This approach presents significant advancements in User Interface (UI) design by introducing adaptive UIs powered by Artificial Intelligence (AI) and Machine Learning (ML). Traditional static UIs often fail to address the specific needs and preferences of individual users, resulting in unnecessary complexity and inefficiency. The proposed system resolves these limitations by generating personalized and dynamic interfaces tailored to users' roles, historical interactions, contextual behaviors, and real-time requirements. Through intelligent automation, customized workflows, and contextual assistance, the invention offers a transformative solution that enhances user experience (UX), reduces cognitive load, and improves productivity.

One of the key benefits is its ability to provide occupational role-specific dashboards and workflows. By analyzing job-related data and historical user interactions, the system dynamically configures interfaces to deliver relevant tools, metrics, and alert systems. For example, cybersecurity analysts are presented with real-time security metrics and threat alerts, while IT administrators receive optimized workflows to automate repetitive tasks. This personalized approach ensures users gain faster access to critical functionalities while minimizing frustration typically associated with navigating static, one-size-fits-all systems.

The system further incorporates modular and scalable design principles, enabling users to select and arrange customizable UI components based on their preferences. AI/ML models continuously learn from user interactions, organizational trends, and global data patterns to refine and evolve the interface over time. Additionally, the invention includes robust guardrails for protecting user privacy and adhering to organizational policies, ensuring safe and secure environments for users. Its dynamic adaptability extends across industries, making it suitable for cybersecurity, healthcare, education, IT management, and more.

By simplifying workflows, enhancing accessibility, and streamlining task management, this approach delivers measurable improvements to end-user efficiency while reducing IT burden for organizations. Its ability to unify software tools under one cohesive platform and automate routine tasks further boosts operational effectiveness. The integration of AI-driven insights and contextual assistance helps users refine their expertise and adapt seamlessly to evolving trends. This innovation provides a groundbreaking shift in UI design, offering practical and technologically advanced solutions with broad applicability across domains and industries.

Conclusion

The foregoing description of example embodiments has been provided for purposes of illustration and description. It is not intended to be exhaustive or to limit the invention to the precise forms disclosed. Numerous modifications, variations, and adaptations may be made without departing from the scope of the concepts described herein. For example, although specific components and processing steps may be described in a particular order or arrangement, such order or arrangement may be altered or omitted in various implementations.

As used herein, the singular forms “a,” “an,” and “the” are intended to include the plural forms as well, unless expressly stated otherwise. It will be understood that the terms “comprising,” “including,” and “having,” as used herein, are intended to be open-ended and indicate the presence of stated features, steps, or components, but do not preclude the presence or addition of one or more other features, steps, components, or groups thereof.

While certain features have been described in the context of specific embodiments, it is contemplated that such features may be combined in any suitable manner, even if such combinations are not explicitly disclosed. The scope of the present disclosure is defined by the appended claims, and all equivalents thereof are intended to be embraced therein.

What is claimed is:

1. A system comprising:
a processing device; and
a memory device configured to store a computer program having instructions that, when executed, enable the processing device to
gather job-related information associated with a user, the job-related information including at least an occupational role of the user,
collect user-driven information associated with the user, the user-driven information including at least historical user interactions, and
customize an adaptive User Interface (UI) for the user based on the job-related information and user-driven information using an Artificial Intelligent/Machine Learning (AI/ML) model.

2. The system of claim 1, wherein the job-related information further includes an organizational team of which the user is a member, and wherein the user-driven information further includes personal selections, preferences, and settings.

3. The system of claim 1, wherein the instructions further enable the processing device to customize the adaptive UI using a Model-View-Presenter (MVP) or Model-View-Controller (MVC) architecture.

4. The system of claim 1, wherein the instructions further enable the processing device to create personalized automated workflows for the user based on identified repetitive tasks and work patterns.

5. The system of claim 1, wherein the instructions further enable the processing device to personalize graphic features and widgets of a homepage of the adaptive UI based on user selections, preferences, and settings.

6. The system of claim 1, wherein the instructions further enable the processing device to personalize a dynamic navigation section and menu options of the adaptive UI based on navigational history and patterns.

7. The system of claim 1, wherein the instructions further enable the processing device to add contextual assistance information to the adaptive UI based on one or more of a) an observation or anticipation of what the user is attempting to accomplish, b) a large amount of data obtained from multiple global users having the same occupational role, and c) behaviors of team members in a network domain associated with the user.

8. The system of claim 1, wherein the instructions further enable the processing device to add intelligent discovery opportunities to the adaptive UI, the intelligent discovery opportunities including suggestions or recommendations for enabling the user to a) learn additional skills, b) gain greater expertise within the occupational role, and/or c) incorporate best practices into a workflow.

9. The system of claim 8, wherein the processing device is configured to add the intelligent discovery opportunities based on an analysis of a) current events within a field of the occupational role, b) issues detected in a network domain associated with the user, c) possible workflow improvements, d) a potential lack of experience or expertise of the user, e) perceived gaps in knowledge, and/or f) underutilized software tools and features for better performing tasks within a realm of the occupational role.

10. The system of claim 1, wherein the AI/ML model is configured to use a continuous learning process that includes:
analyzing new data obtained from a) the user, b) a team associated with the user, and c) global trends, and
reconfiguring the adaptive UI based on the new data.

11. The system of claim 1, wherein the instructions further enable the processing device to:
provide a library of modular UI components from which the user can choose, the library including suggestions commonly associated with the occupational role,
allowing the user to select one or more of the modular UI components, and
arranging and/or rearranging the one or more modular UI components selected by the user according to additional user input.

12. The system of claim 1, wherein the instructions further enable the processing device to format the adaptive UI for presentation on one or more of a desktop computer, laptop computer, a smart phone, and a mobile device.

13. The system of claim 1, wherein the occupational role includes one of a) a cybersecurity analyst, b) a Security Operations Center (SOC) analyst, c) an IT administrator, d) an IT project manager, e) an admin, f) a network operator, g) a hardware technician, h) a software developer, i) a network analyst, j) a database management admin, k) a data scientist, l) a systems admin, m) an information security expert, and n) a help desk assistant.

14. The system of claim 13, wherein the adaptive UI is configured to display security metrics and security alerts related to the occupational role, and wherein the adaptive UI is integrated within a consolidated platform of zero-trust cybersecurity apps, cloud-based apps, and Software as a Service (SaaS) apps.

15. The system of claim 1, wherein the instructions further enable the processing device to create a cohesive platform for the user based on a suite of software products available to the user, and wherein the cohesive platform offers consistency and efficiency.

16. The system of claim 1, wherein the instructions further enable the processing device to construct guardrails to a) protect privacy and Personal Identifiable Information (PII) of the user, b) provide restrictions on what the user can be shown based on organizational policies, and c) prevent display of content considered to be Not Safe (or Suitable) For Work (NSFW).

17. The system of claim 1, wherein the adaptive UI includes a dynamic layout with customized dashboards for the user based on the occupational role, historical interactions, real-time conditions, current needs and requirements of a network domain associated with the user, current trends, user behaviors, and automated workflow patterns.

18. A non-transitory computer-readable medium configured to store computer logic having instructions that, when executed, cause one or more processing devices to:
gather job-related information associated with a user, the job-related information including at least an occupational role of the user;
collect user-driven information associated with the user, the user-driven information including at least historical user interactions; and
customize an adaptive User Interface (UI) for the user based on the job-related information and user-driven information using an Artificial Intelligent/Machine Learning (AI/ML) model.

19. A method comprising the steps of:
gathering job-related information associated with a user, the job-related information including at least an occupational role of the user;
collecting user-driven information associated with the user, the user-driven information including at least historical user interactions; and
customizing an adaptive User Interface (UI) for the user based on the job-related information and user-driven information using an Artificial Intelligent/Machine Learning (AI/ML) model.

20. The method of claim 19, wherein the job-related information further includes an organizational team of which the user is a member, and wherein the user-driven information further includes personal selections, preferences, and settings.
